(19) United States
(12) Patent Application Publication
(10) Pub. No.: US 2010/0248523 A1
(43) Pub. Date: Sep. 30, 2010

(54) FEMALE POWER CONNECTOR, MALE POWER CONNECTOR AND POWER CONNECTOR ASSEMBLY

(75) Inventors: Lei Liu, Shenzhen City (CN); Xiao-Feng MA, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen)CO.,LTD., Shenzhen City (CN); HON HAI PRECISION CO., LTD., Tu-Cheng (TW)

(21) Appl. No.: 12/424,528

(22) Filed: Apr. 15, 2009

(30) Foreign Application Priority Data
Mar. 25, 2009 (CN) 200910301112.X

(51) Int. Cl. H01R 13/629; H01R 24/00; H01R 13/74

(52) U.S. Cl. 439/352; 439/660; 439/552

(57) ABSTRACT

A power connector assembly includes a male power connector and a female power connector engaged in the male power connector. The male power connector includes a main body defining a receiving cavity and a number of terminals positioned in the receiving cavity. The female power connector includes a main body, an inserting portion, and a latching member with elasticity. The latching member includes a latching portion and an actuating portion. The latching portion includes a guiding tab connected to the inserting portion and an engaging tab extending from the guiding tab. The actuating portion extends from the engaging tab. A latching slot is defined in a wall of the main body of the male power connector to engage with the engaging tab to engage the female power connector in the male power connector.

### BACKGROUND

1. Technical Field

Embodiments of the present disclosure relate to power connectors, and more particularly, to a female power connector and a male power connector matching the female power connector.

2. Description of Related Art

Power connector assemblies are indispensable elements for electronic devices. Each power connector assembly includes a female power connector and a male power connector. In use, the female power connector is engaged in the male power connector to supply a power from a power supply for an electrical device via the male power connector. However, some conventional female power connectors are easily disengaged from the male power connectors by accident.

### BRIEF DESCRIPTION OF THE DRAWINGS

FIG. 1 is an isometric view of a first exemplary embodiment of a female power connector.

FIG. 2 is an isometric view of an exemplary embodiment of a male power connector.

FIG. 3 is an assembled, isometric view of the female power connector of FIG. 1 and the male power connector of FIG. 2.

FIG. 4 is an isometric view of a second exemplary embodiment of a female power connector.

### DETAILED DESCRIPTION

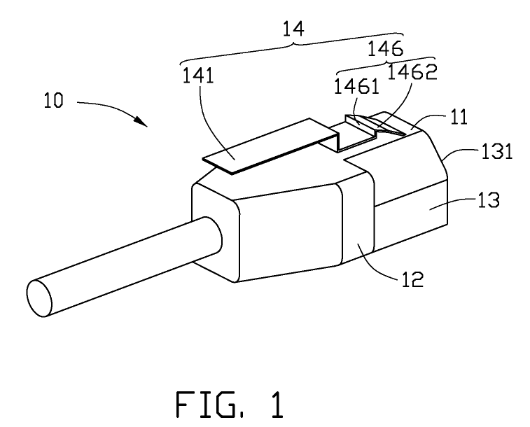

Referring to FIG. 1, a first exemplary embodiment of a female power connector 10 includes a main body 12, an inserting portion 13 ending at an inserting face 131 and extending from the main body 12, and an elastic latching member 14 extending from the inserting portion 13.

One end of the latching member 14 is shaped to act as a latching portion 146 and engage with a male connector. The other end of the latching member 14 is cantilevered over the main body 12 and the inserting portion 13 to facilitate an actuating portion 141 capable of releasing the latching portion 146 from the male connector. The shape of the latching member 14 can be selected as desired to achieve these functions. The latching member 14 includes a latching portion 146 and an actuating portion 141 extending from the latching portion 146. The latching portion 146 includes a guiding tab 1462 connected to a wall 11 of the inserting portion 13 obliquely, and an engaging tab 1461. The guiding tab 1462 slants upwards away from an inserting face 131 along the inserting portion 13. The distal end of guiding tab 1462 perpendicularly extends downwards to the wall 11 to form the engaging tab 1461.

The actuating portion 141 is substantially Z-shaped. The actuating portion 141 perpendicularly extends from the distal end of the engaging tab 1461 away from the inserting face 131 along the wall 11 of the inserting portion 13 and continuously perpendicularly extends up away from the wall 11 of the inserting portion 13, and then perpendicularly extends away from the inserting face 131 along the main body 12.

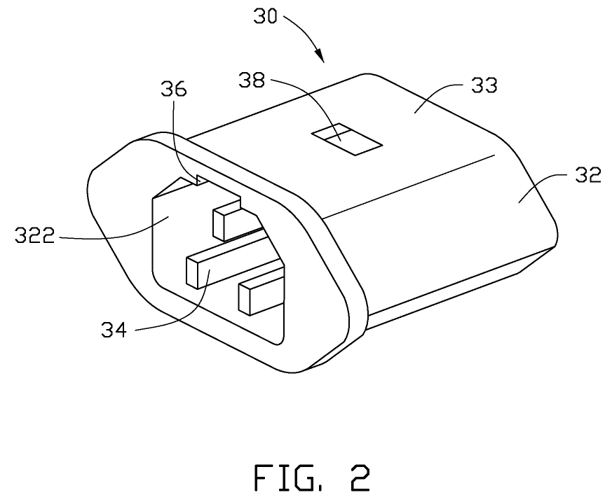

Referring to FIG. 2, an exemplary embodiment of a male power connector 30 includes a main body 32 and a plurality of terminals 34. A receiving cavity 322 is defined in the main body 322 to receive the inserting portion 13 of the female power connector 10. The plurality of terminals 34 is positioned in the receiving cavity 322 to electrically engage with the female power connector 10. A sliding groove 36 is defined in an inner wall of the receiving cavity 322. A latching slot 38 is defined in a wall 33 of the main body 32, communicating with the sliding groove 36 and passing through the wall 33. In another embodiment, the latching slot 38 may be defined in a bottom wall of the sliding groove 36.

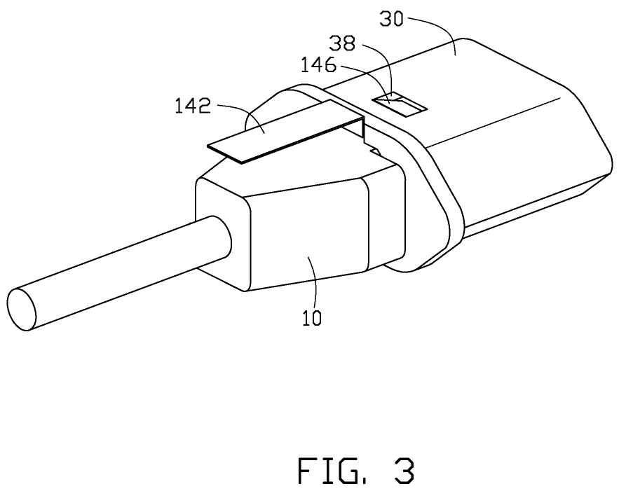

Referring to FIG. 3, in use, the female power connector 10 is engaged with the male power connector 30, to transmit power from the female power connector 10 to the male power connector 30. The inserting portion 13 of the female power connector 10 is inserted into the receiving cavity 322 of the male power connector 30. The latching member 14 of the female power connector 10 deforms as the latching member 14 slides in the sliding groove 36 of the male power connector 30. The latching member 14 then restores in response to the latching portion 146 aligning with the latching slot 38, to be engaged in the latching slot 38. Therefore, the female power connector 10 is engaged in the male power connector 30. A sidewall bounding the latching slot 38 blocks the engaging tab 1461 of the latching portion 146, to prevent the female power connector 10 from disengaging from the male power connector 30.

When the female power connector 10 needs to be released from the male power connector 30, the actuating portion 141 is pressed toward the main body 12 to deform the latching portion 146 towards the wall 11 of the female power connector 10, to release the engaging tab 1461 from the latching slot 38. Therefore, the female power connector 10 can be easily removed from the male power connector 30.

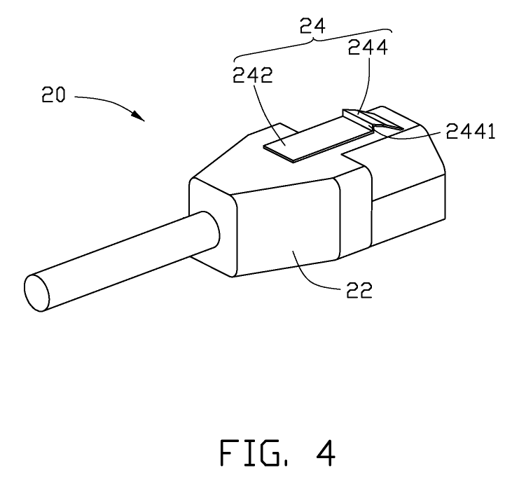

Referring to FIG. 4, a difference between a second exemplary embodiment of a female power connector 20 and the female power connector 10 of the first exemplary embodiment is that an actuating portion 242 of a latching member 24 of the female power connector 20 is a flat plate. Also, the actuating portion 242 extends from the distal end of the engaging tab 2441 away from the inserting face 131 along the main body 22 from the latching portion 244 perpendicularly.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A female power connector configured to matching a male power connector, comprising:
a main body;
an inserting portion extending from the main body; and
an elastic latching member extending from the inserting portion, the latching member comprising:
a latching portion comprising a guiding tab connected to the inserting portion, and an engaging tab extending from the guiding tab to engage with the male power connector; and
an actuating portion extending from the engaging tab of the latching portion;
wherein the actuating portion is capable of being operated to deform the latching portion, resulting in releasing the female power connector from the male power connector.

2. The female power connector of claim 1, wherein the guiding tab is extended form a wall of the inserting portion obliquely, the guiding tab slants upwards away from an inserting face of the inserting portion along the inserting portion, the distal end of the guiding tab then perpendicularly extends downwards to the wall to form the engaging tab.

3. The female power connector of claim 2, wherein the actuating portion is substantially Z-shaped, the actuating portion perpendicularly extends from the distal end of the engaging tab away from the inserting face along the wall of the inserting portion and continuously perpendicularly extends up away from the wall of the inserting portion, and then perpendicularly extends away from the inserting face along the main body.

4. The female power connector of claim 2, wherein the actuating portion perpendicularly extends from the distal end of the engaging tab away from the inserting face along the wall of the inserting portion.

5. A male power connector configured to match a female power connector, comprising:
a main body defining a receiving cavity; and
a plurality of terminals positioned in the receiving cavity;
wherein a latching slot is defined in a wall bounding the receiving cavity of the main body, to engage with the female power connector.

6. The male power connector of claim 5, wherein a sliding groove is defined in an inner wall of the receiving cavity.

7. The male power connector of claim 6, wherein the latching slot communicates with the sliding groove and passes through a wall bounding the main body.

8. The male power connector of claim 6, wherein the latching slot is defined in a bottom wall of the sliding groove.

9. A power connector assembly comprising:
a male power connector comprising:
a main body defining a receiving cavity; and
a plurality of terminals positioned in the receiving cavity; and
a female power connector comprising:
a main body;
an inserting portion extending from the main body; and
a latching member with elasticity extending from the inserting portion, the latching member comprising:
a latching portion comprising a guiding tab connected to the inserting portion and an engaging tab extending from the guiding tab to engage with the male power connector; and
an actuating portion extending from the engaging tab of the latching portion;
wherein a latching slot is defined in a wall bounding the receiving cavity of the main body to engaging with the engaging tab, to engage the female power connector in the male power connector, the actuating portion is capable of being operated to deform the latching portion to release the female power connector from the male power connector.

10. The power connector assembly of claim 9, wherein the guiding tab is extended from a wall of the inserting portion obliquely, the guiding tab slants upwards away from an inserting face of the inserting portion along the inserting portion, the distal end of the guiding tab then perpendicularly extends down adjacent the wall to form the engaging tab.

11. The power connector assembly of claim 10, wherein the actuating portion is substantially Z-shaped, the actuating portion perpendicularly extends from the distal end of the engaging tab away from the inserting face along the wall of the inserting portion and continuously perpendicularly extends up away from the wall of the inserting portion, and then perpendicularly extends away from the inserting face along the main body.

12. The power connector assembly of claim 10, wherein the actuating portion perpendicularly extends from the distal end of the engaging tab away from the inserting face along the wall of the inserting portion.

13. The power connector assembly of claim 9, wherein a sliding groove is defined in an inner wall of the receiving cavity of the male power connector, to slidably receiving the latching member of the female power connector.

14. The power connector assembly of claim 13, wherein the latching slot communicates with the sliding groove and passes through a wall bounding the receiving cavity.

15. The power connector assembly of claim 13, wherein the latching slot is defined in a bottom wall of the sliding groove.
